(19) United States
(12) Patent Application Publication
(10) Pub. No.: US 2023/0319184 A1
(43) Pub. Date: Oct. 5, 2023

(54) SYSTEM AND METHOD ENABLING A USER TO SELECT AN AUDIO STREAM OF CHOICE

(71) Applicant: JLAK ROTHWELL PTY LTD, Kangaroo Ground, Victoria (AU)

(72) Inventor: Jason ROWELL, Kangaroo Ground, Victoria (AU)

(21) Appl. No.: 18/041,866

(22) PCT Filed: Aug. 19, 2021
(86) PCT No.: PCT/AU2021/050919

§ 371 Date: Feb. 16, 2023

(30) Foreign Application Priority Data
Aug. 20, 2020 (AU) 2020902969

(51) Int. Cl. H04M 1/72403; H04M 3/428; H04M 3/51

(52) U.S. Cl. CPC H04M 3/4285; H04M 1/72403; H04M 3/5175; H04M 2201/40

(57) ABSTRACT

The present application relates to a system and method of enabling a user to select an audio stream of choice. The application is particularly suited to circumstances in which a user has commenced an audio or video call to communicate with another person. More particularly, in instances where the user is placed “on-hold” whilst the person with whom the user seeks to communicate is either located or otherwise unavailable. The user who is placed “on-hold” may prefer to listen to an audio stream other than the audio stream provided by default to the user whilst “on-hold” and the present application is particularly well suited to enabling the user to select an audio stream of choice whilst “on-hold” waiting to speak with another person.

### FIELD OF THE INVENTION

The present invention relates to a system and method of enabling a user to select an audio stream of choice. The invention is particularly suited to circumstances in which a user has commenced an audio or video call to communicate with another person. More particularly, in instances where the user is placed “on-hold” whilst the person with whom the user seeks to communicate is either located or otherwise unavailable. The user who is placed “on-hold” may prefer to listen to an audio stream other than the audio stream provided by default to the user whilst “on-hold” and the present invention is particularly well suited to enabling the user to select an audio stream of choice whilst “on-hold” waiting to speak with another person.

### BACKGROUND OF THE INVENTION

Organisations are increasingly establishing, or using the services, of call centres in which operators receive calls from the general public, or otherwise interested parties, and seek to address queries that are relevant to the organisation in respect of which the call centre provides services.

Whilst call centres represent an efficient model by which organisations may receive and process queries from the general public, and/or otherwise interested parties, it is not uncommon for call centres to experience a substantial number of calls during peak periods and as a result, users who call the call centre are often placed “on-hold” whilst the human operator with whom they initiated the call seeks to either locate another more relevant person to connect the user with, or seeks to determine a response to the user’s query. In other instances, users are commonly placed “on-hold” whilst they await their turn in a queue to be addressed by a human operator at the call centre.

Whilst placed “on-hold”, it is also a common practice for call centres to provide an audio stream to the user who initiated the call wherein the audio stream provided generally includes either a musical score or melody, or in some instances, a combination of music and spoken voice in which the spoken voice provides additional information or promotional messages regarding the organisation for which the call centre provides services.

Increasingly, the period of time that users are required to wait for service from a call centre is becoming significant and it is not unusual for users to sometimes experience waiting periods of 30 to 45 minutes or even longer in some instances. The substantial period of time in which a user is sometimes required to wait for service from a call centre, or await the availability of a relevant person with whom they can communicate, requires users to listen to the music and/or promotional spoken word provided by the call centre which can become monotonous and repetitive particularly when the user is required to listen to the musical score and/or spoken word for a substantial period of time.

Accordingly, there is a need to provide users with the ability to select an audio stream of choice such that they can avoid listening to the pre-selected musical score and/or spoken word promotional audio stream activated by a call centre, or any organisation with whom a user is engaged with during an audio or video call, and who provides pre-recorded music and/or spoken word messages during “on-hold” periods of time. The ability to select an audio stream of choice enables the user to select a preferred audio stream whilst the user is “on-hold”.

Accordingly, the system and method of the present invention seeks to address the above described problem or at least provide an alternative to current arrangements.

### SUMMARY OF THE INVENTION

In one aspect, the present invention provides a method enabling a caller who has initiated an audio connection with a service for the purpose of communicating with a human operator to select a preferred audio stream whilst awaiting the human operator, the method including the steps of the caller initiating an audio connection with a service, with a user device including one or more processors, a microphone and an audio speaker, the user device further including a software application executable by the one or more user device processors and, operable to be activated by the caller in the event the caller is placed “on-hold” during the user initiated call, the activated software application operable to disconnect the “on-hold” audio stream from the audio speaker of the user device and replacing the “on-hold” audio stream directed to the audio speaker with an audio stream selected, or pre-selected, by the caller, the replacement on-hold audio stream including any audio stream accessible by the user device; the software application operable to monitor the “on-hold” audio stream to determine cessation of the “on-hold” audio stream according to feedback from a learning module with historical caller feedback provided as input to confirm successful, or unsuccessful, transitions between “on-hold” audio streams and real-time human voice utterings, the learning module recording either successful, or unsuccessful transitions, or both, and the circumstances leading to the transition to improve reliability of transitions; and upon detection of cessation of the “on-hold” audio stream, the software application reconnecting the audio speaker of the user device to the audio connection with the service such that the caller can listen to, and communicate with, the human operator.

In an embodiment, the software application is further operable to automatically detect any transition of the audio stream from a human operator to an “on-hold” audio stream and automatically direct a pre-selected audio stream of choice, pre-selected by the user, to the audio speaker of the user’s device whilst monitoring the “on-hold” audio stream to detect a cessation of the “on-hold” audio stream and reversion of that audio stream back to a human operator. Upon detecting the cessation of the “on-hold” audio stream, the software application is further operable to direct the audio stream including the audio of a human operator to the speaker device thereby disconnecting the pre-selected preferred audio stream and thereby reverting the user once again to the human operator thereby enabling the user to further communicate with the human operator.

In another embodiment, the software application effects transition between the alternative audio streams by detecting the difference between “on-hold” audio streams and human voice interaction. Whilst basic techniques are available to detect and determine the difference between an “on-hold” audio stream and genuine human voice interaction subsequent to the cessation of an “on-hold” audio stream, in an embodiment, the available basic techniques are enhanced by the creation of a library of different voice styles including parameters such as pitch, volume and tonality such that the software application may use the library to better detect the difference between a pre-recorded audio stream for the purposes of “on-hold” audio and real time human voice utterings. This embodiment is particularly useful where the “on-hold” audio stream provided by a particular call centre service provider includes human voice for the purpose of announcing promotional messages and/or additional information that may be helpful to callers whilst they are placed “on-hold”.

In the embodiment including a library of different voice styles, the library may also take into account different background noise conditions to further improve the ability of the software application to determine the difference between a pre-recorded audio stream for the purpose of directing to users who are placed “on-hold” as compared with real time human voice interaction.

In another embodiment, the software application includes a “learning module” with caller feedback provided as input to confirm successful, or unsuccessful, transitions between “on-hold” audio streams and human voice interaction. With the benefit of user feedback regarding those instances in which the software application has successfully transitioned between “on-hold” audio streams and real human voice interaction as compared with those unsuccessful transitions, the learning module utilises the user feedback to identify the successful and unsuccessful transitions and identify the parameters associated with successful and unsuccessful transitions to improve any future attempt to detect and determine a transition between “on-hold” audio streams and real time (non-recorded) human voice utterings.

In another embodiment, the software application applies a “stabiliser” to audio streams for the purpose of improving performance. A stabiliser suppresses background noise in an audio system by analysing the audio signal and determining those components of the signal that represent noise, such as “white noise” and removes those components from the audio signal. Removal of “noise” signal components from an audio stream increases the clarity of the remaining signal components and hence, improves the ability to assess and determine the difference between a recorded human voice and utterances in real-time which may otherwise be complicated by the presence of noise in the audio signal.

In another embodiment including a learning module, the learning module monitors callers’ audio streams and develops a data base of audio conditions such as background noise and white noise such that the software application may learn to avoid sound distractions and hence, learn to avoid false transitions of audio streams in response to those noise conditions.

In yet another embodiment, a vocal recognition algorithm is incorporated and/or used by the software application to generate a “vocal fingerprint” regarding different voice pitches including male and female variations thereby enabling the learning module to improve the software application’s ability to recognise the difference between “on-hold” audio streams as compared with real time human voice utterings.

In another aspect, the present invention provides a system enabling a caller who has initiated an audio connection with a service for the purpose of communicating with a human operator to select a preferred audio stream whilst awaiting the human operator, the system including, a user device including one or more processors, a microphone, an audio speaker, and a software application executable by the one or more processors to, enable the caller to initiate an audio connection with a service, enable the caller in the event the caller is placed “on-hold” during the user initiated call, disconnect the “on-hold” audio stream from the audio speaker of the user device and replace the “on-hold” audio stream directed to the audio speaker with an audio stream selected, or pre-selected, by the caller, monitor the “on-hold” audio stream to determine cessation of the “on-hold” audio stream according to feedback from a learning module with historical caller feedback provided as input to confirm successful, or unsuccessful, transitions between “on-hold” audio streams and real-time human voice utterings, the learning module recording either successful, or unsuccessful transitions, or both, and the circumstances leading to the transition to improve reliability of transitions, and upon detection of cessation of the “on-hold” audio stream, reconnect the audio speaker of the user device to the audio connection with the service such that the caller can listen to, and communicate with, the human operator.

In yet another aspect, the present invention provides a computer readable medium storing instructions that enable a caller who has initiated an audio connection with a service for the purpose of communicating with a human operator to select a preferred audio stream whilst awaiting the human operator, the instructions including, activating a software application on a user device in the event the caller, who has initiated an audio connection with a service using the user device, is placed “on-hold” during the initiated call, the user device including a microphone and an audio speaker, disconnecting the “on-hold” audio stream from the audio speaker of the user device and replacing the “on-hold” audio stream directed to the audio speaker with an audio stream selected, or pre-selected, by the caller, monitoring the “on-hold” audio stream to determine cessation of the “on-hold” audio stream including receiving feedback from a learning module that has previously received caller feedback as input confirming successful, or unsuccessful, transitions between “on-hold” audio streams and real-time human voice utterings, the learning module recording other successful, or unsuccessful transitions, or both, and the circumstances leading to the transition to improve reliability of transitions; and upon detection of cessation of the “on-hold” audio stream, reconnecting the audio speaker of the user device to the audio connection with the service such that the caller can listen to, and communicate with, the human operator.

### BRIEF DESCRIPTION OF THE DRAWINGS

Features of the present disclosure are illustrated by way of example and not limited in the following figure(s), in which like numerals indicate like elements, in which:

FIG. 1 illustrates an exemplary computer-implemented system for enabling a user to select an audio stream of choice when placed on-hold in accordance with the present invention;

FIG. 2 illustrates an exemplary flow diagram of a process that enables a user to download and install a software application and subsequently login, or register, to use the software application for interacting with the system illustrated in FIG. 1;

FIG. 3 illustrates an exemplary flow diagram of the software application interfacing with hardware components associated with the user device, including a microphone and audio speaker;

FIG. 4 illustrates an exemplary flow diagram of a communication which takes place between a user device on which the software application is operable and a call management system associated with a call centre or similar organisation; and

FIG. 5 illustrates an exemplary flow diagram of a process that enables the software application operable on the user device to replace an “on-hold” audio stream with an audio stream selected, or pre-selected, by the user.

### DETAILED DESCRIPTION OF EMBODIMENT(S) OF THE INVENTION

The present invention relates to at least a computer-implemented system and method that enables a user (caller) (10), who has initiated (140) an audio connection with a service (e.g. human operator (130)), to select (90) a preferred audio stream (75) whilst waiting for the human operator (130) to commence, or return to, a conversation (190) (i.e. during the period of time that the user (10) is placed on-hold). In particular, the system includes a user device (20), which may be the user’s mobile phone (including a microphone and audio speaker), wherein the software application (30) becomes activated after the caller (10) initiates an audio connection with a device operated by the human operator (130) and the user is placed “on-hold”.

Upon establishment of an audio connection, an audio stream (55) is initiated between the two devices, which audio stream involves a conversational audio stream (190) during which the user (10) and human operator (130) speak directly with one another, and an “on-hold” audio stream (145) during which the user (10) is placed on-hold and call management software (120) causes informational messages (150) and/or on-hold music (155) to play. The skilled addressee would appreciate that the “on-hold” audio stream (145) can be initiated as soon as, or soon after, an audio connection is established where the user (10) is automatically placed on-hold prior to speaking with an operator (130), or the user (10) may be placed on-hold after engaging in conversation with the operator (130), e.g. before the call is transferred to another person within the organisation.

The software application (30) is operable to disconnect the “on-hold” audio stream (145) from the audio speaker of the user device (20) and bypass (110) the “on-hold” audio stream (145) with an audio stream (90) selected, or pre-selected, by the caller (10). The “on-hold” audio stream (145) continues to be operable and is monitored in the background to determine cessation of the “on-hold” audio stream (145), i.e. reversion of the audio stream (145) back to a conversational audio stream (190) when the user (10) is no longer “on-hold”. Upon detection of such cessation, the application (30) reconnects the audio speaker of the user device (20) to the audio stream of the call such that the caller (10) can listen to, and further communicate with, the human operator (130).

It is to be understood that the software application (30) may be activated to operate in the above described manner irrespective of whether it is the user (10) who initiated the call or the human operator (130) who initiated the call.

The skilled addressee would appreciate that the above described system and method allows users (10) to select their own audio stream to play when they are placed “on-hold” by bypassing an on-hold audio stream (145) to audio chosen by the user. In this way, rather than listening to on-hold audio, users can listen to their own music, podcasts, audiobooks, or any other media whilst the application (30) monitors the on-hold audio stream to determine reversion of the audio stream back to the human operator (130).

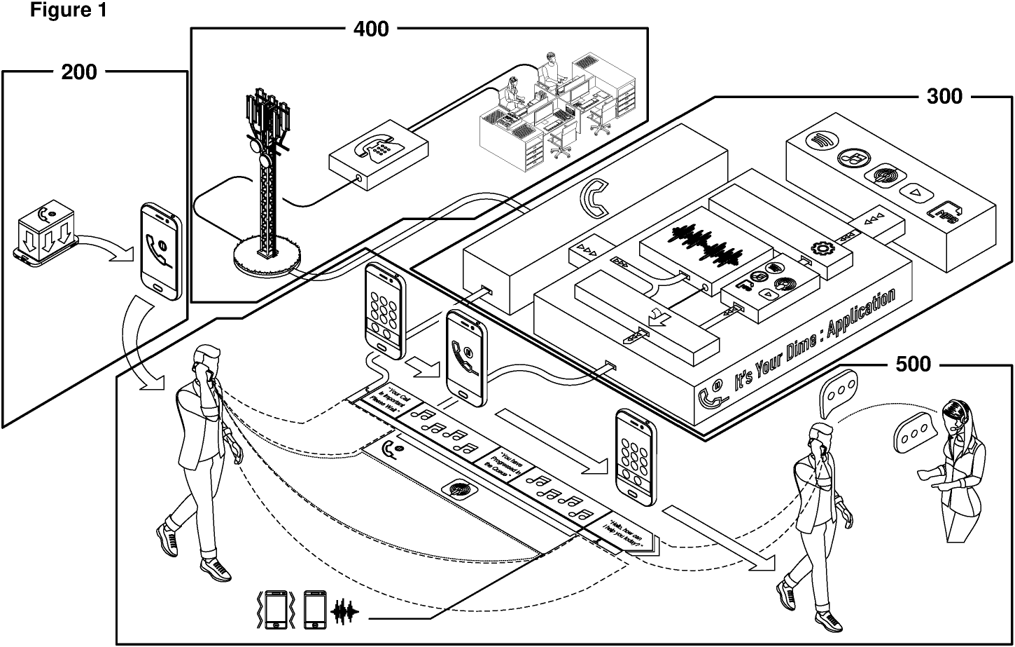

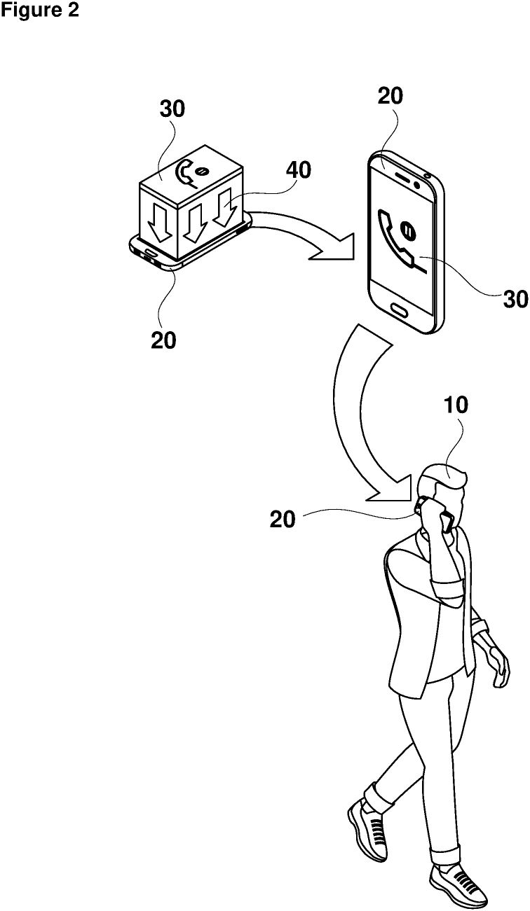

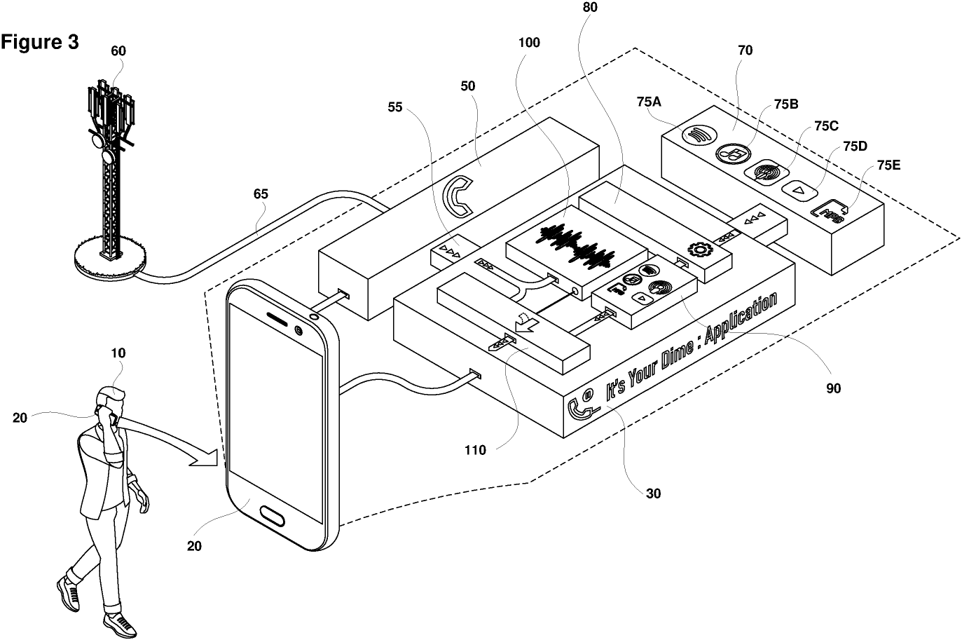

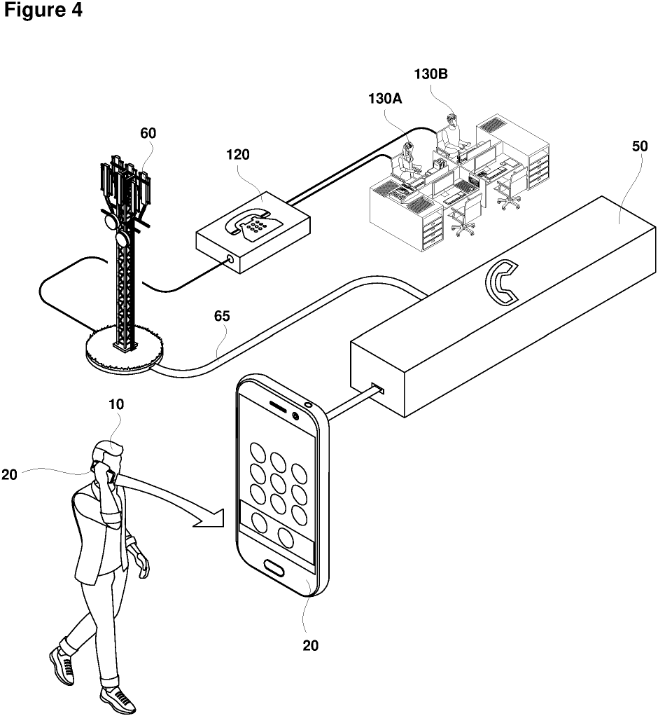

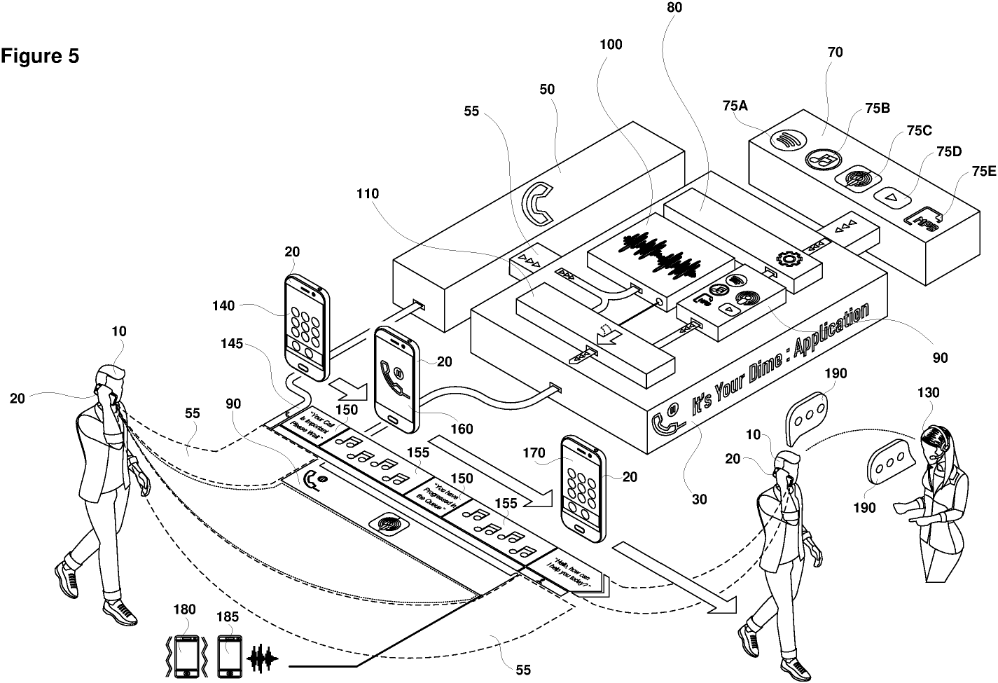

FIG. 1 is divided into segments which are further expanded in the subsequent FIGS. 2 to 5. In particular, segment 200 of FIG. 1 shows the user (10) downloading and installing the application (30), which is expanded in FIG. 2. Segment 300 of FIG. 1 shows the components of the software application (30) and additional user device components/functionality with which the application (30) has an interface, according to an embodiment. This is expanded in FIG. 3. Segment 400 of FIG. 1 shows a typical organisation that receives calls and manages them using call management software (120) that initiates call waiting / on-hold audio, as expanded in FIG. 4. Finally, segment 500 of FIG. 1 shows the operation of software application (30) in bypassing the on-hold audio stream (145) with the selected alternate audio stream (90), which is expanded in FIG. 5.

The steps described herein may be carried out using a user device (20) capable of communication (65) across a telephony, data or similar network (60) with a device associated with a human operator (130) operating call management software (120). Whilst not shown, any storage and/or functionality that cannot be provided locally on the user device (20) could be provided externally, e.g. by an external server (not shown) programmed to provide such storage and/or functionality.

FIG. 2 shows the user device (20) being operated by the user (10) to install the application (30), which may be achieved by downloading the application (30) from an Application store. The user (10) may create an account using the application (30), and the account information may be stored in a user account register (not shown) associated with the device or some other external storage means. The user account may capture information sufficient to enable the users to be correctly identified. The process of installing the application (30) is indicated by arrows (40). The user may be required to pay a subscription fee for use of the application (30).

With reference to FIG. 3, there is illustrated call functionality (50) associated with the user device (20) which allows the user (10) to make and receive phone calls via a telephony, data or similar network (60). Once connection has been established with another user, e.g. human operator (130), a call audio stream (55) is established and, as mentioned previously, this call audio stream may include different types of communication including direct conversation (190) between the users, and an automated audio stream where, for example, the user (10) is placed on-hold and thereby receives call waiting / on-hold audio such as music (155) and/or informational messages (150).

FIG. 3 also shows that the application (30) has access to a repository (70) in which available alternate audio streams (70) are stored, thereby allowing the user (10) to select any alternate audio source such as music, podcasts, audiobooks, or other media such as videos, whilst the application (30) monitors the audio stream (55) and in particular, any changes in the audio stream (55) (e.g. change from the on-hold audio stream (145) back to the conversational audio stream (190)). Examples of available alternate audio streams (70) include the Spotify® streaming service (75A), other music streaming services (75B), podcasts (75C), YouTube® (75D), or music (75E) that is stored in the device (20) such as music in MP3 format.

User preferences and settings (80) may also be stored and accessed by the application (30), and such preferences and settings may stipulate which of the available alternate audio streams (70) to which the user would prefer to listen as compared with the audio stream (145) associated with call management software (120). The alternate audio streams that have been selected by the user are also shown in FIG. 3 as stored in repository (90), which repository may be present locally on user device (20) or the subject of remote storage as described previously.

In order to monitor and identify when the audio stream has reverted back from a call waiting or on-hold audio stream (145), such as music (155) for example, to a direct conversation audio stream (190), audio analysis functionality (100) may be utilised. For example, such functionality (100) may process and analyse the call audio stream (55) and identify when the on-hold audio stream (145) ceases and the conversational audio stream (190) wither commences or resumes. The functionality (100) may subsequently cause an associated audio stream switch (110) to cease bypassing the call audio stream (55), i.e. based upon whether or not the analyser (100) determines that there is an on-hold audio stream (145) active. This functionality is described in greater detail with respect to the particular embodiment of FIG. 5 below.

FIG. 4 shows a typical organisation that may receive calls and manage calls using call management software (120), and where human operators such as operators (130A) and (130B) are tasked with receiving calls, e.g. calls from user (10) using call functionality (50) associated with user device (20). As mentioned above, the call management software (120) will typically operate its own call waiting / on-hold audio stream (145), such as music (155) and/or informational messages (150). This audio stream (145) will typically be activated when the operator (130) is required to place the user (10) on-hold. For example, the user (10) may be placed on-hold at the commencement of the audio connection, or to enable the operator (130) to direct the user’s call to another person within the organisation, or to enable the operator (130) to gather information in reply a particular query from the user (10) which information may not be readily accessible and hence requires the user (10) to wait for a period of time.

FIG. 5 illustrates an example of the present invention when in use according to a particular embodiment, involving user (10) initiating (140) a phone call with an operator (130) using mobile device (20), with the user (10) being placed on-hold at some point following establishment of an audio connection. When the user (10) is placed on-hold, the call audio stream (55) switches to an on-hold audio stream (145), e.g. a combination of informational messages (150) and on-hold music (155). An example of an informational audio message is “Your call is important, please wait” or “You have progressed in the queue”, etc. An example of on-hold music (155) may be any music that is selected by the particular organisation (e.g. a particular radio station) or is predefined in accordance with the call management software (120).

It is the informational messages (150) and/or on-hold music (155) in respect of which the user (10) may prefer not to listen whilst remaining on-hold, and once application (30) recognises that the audio stream (55) has switched to an on-hold audio stream (145), the application (30) may be activated (160) to bypass the audio stream (55) and replace same with the selected alternate audio stream (90), to which the user (10) would prefer to listen whilst on-hold.

Through continued monitoring, the application (30) will recognise when the audio stream (55) switches or reverts back to a conversational audio stream (190), i.e. when the operator (130) ceases to place the user (10) on-hold. In this regard, the user (10) can be alerted to the switching or reversion of the audio stream (55) back to the human operator (130), either by device vibration (180) or an audio alert (185) for example. The type of alert that is selected may depend upon pre-defined user preferences. The user is then free to commence or resume a conversation with the operator (130).

It is to be understood that the automatic detection of a transition between the alternative audio streams described above may be achieved using various suitable techniques capable of detecting and determining the difference between an “on-hold” audio stream (145) and a genuine human voice interaction, i.e. conversational audio stream (190). However, such techniques may be enhanced by the creation of a library (not shown) of different voice styles including parameters such as pitch, volume and tonality such that the software application (30) may utilise the library to better detect the difference between pre-recorded audio such as that which will play during an on-hold audio stream (145) and real-time human voice utterings such as those that occur during a conversational audio stream (190). This embodiment is particularly useful where the “on-hold” audio stream (145) provided by a particular call centre includes human voice for the purpose of announcing promotional and/or informational messages (150) whilst users are on-hold. Such a library may also take into account different background noise conditions to further improve the ability of the application (30) to determine the difference between an on-hold audio stream (145) and a conversational audio stream (190).

The application (30) may also include a learning module (not shown) which may receive, as input, caller feedback relating to whether transitions between on-hold audio streams (145) and conversational audio streams (190) were successful or unsuccessful. In this way, the learning module may utilise user feedback to identify the successful and unsuccessful transitions, and may identify the parameters associated with successful and unsuccessful transitions to improve any future attempts to detect and determine such transitions.

The software application (30) may further utilise a stabiliser (not shown) for the purpose of suppressing background noise in an audio system thereby improving transition performance. By determining components of a signal that represent noise, such as white noise, and removing those components from the audio signal, the clarity of the remaining signal components may be increased and the ability to assess and determine the difference between a recorded human voice and real-time human utterances may be improved.

The abovementioned learning module may also be used to develop a database of audio conditions such as background noise and white noise such that the software application (30) may learn to avoid sound distractions and hence learn to avoid false transitions of audio streams in response to those particular noise conditions. Further, a local recognition algorithm may be used by the software application (30) to generate a vocal fingerprint regarding different voice pitches including male and female variations, thereby enabling the learning module to improve the software application’s ability to recognise the difference between on-hold audio streams as compared with real-time human voice utterances.

The benefits arising from the present invention should now be appreciated. Use of the application (30) enables a user (10) to choose the audio stream to which they will listen in place of on-hold music and/or messages. Once the application (30) is activated and the on-hold audio stream (145) is replaced by audio selected by the user, the application (30) monitors the audio stream (55) with a view to cease bypassing the audio stream (55) when the audio (stream) commences or reverts back to a conversational audio stream (145), i.e. real-time human voice interaction once the human operator (130) answers the call, returns to the conversation or directs the call to another human to whom the caller has been directed. Accordingly, the application (30) allows users to select any alternate audio source such as music, podcasts, audiobooks, or even videos, whilst the application (30) monitors the audio stream for transition between the alternative streams.

Throughout this specification and claims which follow, unless the context requires otherwise, the word “comprise”, and variations such as “comprises” and “comprising”, will be understood to mean the inclusion of a stated feature or step, or group of features or steps, but not the exclusion of any other feature or step, or group of features or steps.

The reference to any prior art in this specification is not, and should not be taken as, an acknowledgement or any suggestion that the prior art forms part of the common general knowledge.

The claims defining the invention are as follows:

1-11. (canceled)

12. A method enabling a caller who has initiated an audio connection with a service for the purpose of communicating with a human operator to select a preferred audio stream whilst awaiting the human operator, the method including the steps of:
the caller initiating an audio connection with a service with a user device including one or more processors, a microphone and an audio speaker;
the user device further including a software application executable by the one or more user device processors and operable to be activated by the caller in the event the caller is placed “on-hold” during the user initiated call, the call thereby receiving an “on-hold” audio stream;
the activated software application operable to disconnect the “on-hold” audio stream from the audio speaker of the user device and replacing the “on-hold” audio stream directed to the audio speaker with a preferred audio stream selected, or pre-selected, by the caller, the preferred “on-hold” audio stream including any audio stream accessible by the user device;
the software application operable to monitor the “on-hold” audio stream to determine cessation of the “on-hold” audio stream according to feedback from a learning module with historical caller feedback provided as input to confirm successful, or unsuccessful, transitions between “on-hold” audio streams and real-time human voice utterings, the learning module recording either successful, or unsuccessful transitions, or both, and the circumstances leading to the transition to improve reliability of transitions; and
upon detection of cessation of the “on-hold” audio stream, the software application causing prompt reconnection of the audio speaker of the user device to the audio connection with the service such that the caller can listen to, and communicate with, the human operator.

13. The method according to claim 12 wherein the software application is executed by the one or more processors at the time a caller initiates an audio connection with a service wherein the software application is further operable to:
automatically detect a transition of the audio from the service to an “on-hold” audio stream;
automatically direct a pre-selected audio stream of choice to the audio speaker of the user device whilst monitoring the “on-hold” audio stream to detect a cessation of the “on-hold” audio stream; and
upon detecting the cessation of the “on-hold” audio stream, re-connect audio connection with the service to the audio service thereby disconnecting the pre-selected preferred audio stream and enabling the caller to listen to the audio from the connection with the service.

14. The method according to claim 13 wherein the software application effects transition between alternative audio streams by detecting the difference between “on-hold” audio streams and real-time human voice utterings.

15. The method according to claim 14 wherein the software application automatically detects the difference between “on-hold” audio streams and real-time human voice utterings by reference to a library of different voice styles including any one or more of the following parameters:
pitch;
volume; and
tonality;
such that the software application may use the library to conduct comparisons between the audio signals saved in the library and the audio signal of the present audio stream to determine whether the audio stream directed to the audio output of the user’s device is “on-hold” audio or a real-time human voice uttering.

16. The method according to claim 15 wherein the library of voice styles includes voice styles with differing background noise conditions thereby providing a greater diversity of audio signals for comparison with the audio signal of the real-time audio stream received by the user device.

17. The method according to claim 12 wherein the software application includes a stabiliser applied to audio streams to improve performance of the method, the stabiliser suppressing background noise in an audio stream by analysing the audio signal and determining those components representing noise and removing the noise components from the audio signal.

18. The method according to claim 12 wherein the learning module monitors audio streams and develops a database of audio conditions according to user input such that the learning module recognises background noises and learns to remove, or ignore, background noises when analysing audio signals thereby reducing the prospect of causing false transitions between audio streams in response to the audio signal of an audio stream.

19. The method according to claim 12 wherein the software application includes a vocal recognition algorithm incorporated to generate a vocal fingerprint representative of different voice pitches, including both male and female variations, thereby enabling the learning module to improve the ability of the software application to recognise the difference between “on-hold” audio streams as compared with real-time human voice utterings.

20. A system enabling a caller who has initiated an audio connection with a service for the purpose of communicating with a human operator to select a preferred audio stream whilst awaiting the human operator, the system including:
a user device including one or more processors, a microphone, an audio speaker, and a software application executable by the one or more processors to:
enable the caller to initiate an audio connection with a service;
enable the caller in the event the caller is placed “on-hold” during the user initiated call, to disconnect the “on-hold” audio stream from the audio speaker of the user device and replace the “on-hold” audio stream directed to the audio speaker with a preferred audio stream selected, or pre-selected, by the caller;
monitor the “on-hold” audio stream to determine cessation of the “on-hold” audio stream according to feedback from a learning module with historical caller feedback provided as input to confirm successful, or unsuccessful, transitions between “on-hold” audio streams and real-time human voice utterings, the learning module recording either successful, or unsuccessful transitions, or both, and the circumstances leading to the transition to improve reliability of transitions; and
upon detection of cessation of the “on-hold” audio stream, cause prompt reconnection of the audio speaker of the user device to the audio connection with the service such that the caller can listen to, and communicate with, the human operator.

21. A computer readable medium storing instructions that enable a caller who has initiated an audio connection with a service for the purpose of communicating with a human operator to select a preferred audio stream whilst awaiting the human operator, the instructions when executed by one or more processors, causing:
activating a software application on a user device in the event the caller, who has initiated an audio connection with a service using the user device, is placed “on-hold” during the initiated call, the user device including a microphone and an audio speaker;
disconnecting the “on-hold” audio stream from the audio speaker of the user device and replacing the “on-hold” audio stream directed to the audio speaker with a preferred audio stream selected, or pre-selected, by the caller;
monitoring the “on-hold” audio stream to determine cessation of the “on-hold” audio stream including receiving feedback from a learning module that has previously received caller feedback as input confirming successful, or unsuccessful, transitions between “on-hold” audio streams and real-time human voice utterings, the learning module recording other successful, or unsuccessful transitions, or both, and the circumstances leading to the transition to improve reliability of transitions; and
upon detection of cessation of the “on-hold” audio stream, causing prompt reconnection of the audio speaker of the user device to the audio connection with the service such that the caller can listen to, and communicate with, the human operator.
